(19) United States
(12) Patent Application Publication
(10) Pub. No.: US 2005/0030836 A1
(43) Pub. Date: Feb. 10, 2005

(54) Watch with mirror dial plate

(76) Inventors: Tom Burns, Berkley, CA (US); Xuzhi Qin, Hacienda Heights, CA (US)

Correspondence Address: INSKEEP INTELLECTUAL PROPERTY GROUP, INC, 1225 W. 190TH STREET, SUITE 205, GARDENA, CA, 90248, US

(21) Appl. No.: 10/818,703

(22) Filed: Apr. 5, 2004

Related U.S. Application Data
(60) Provisional application No. 60/460,445, filed on Apr. 4, 2003.

(51) Int. Cl. G04C 17/00

(52) U.S. Cl. 368/232

(57) ABSTRACT

A watch has a mirror dial plate assembly comprising a light valve layer, and a light reflective layer. The light valve is controlled by an electronic circuit for its on, off, and variable light transmission. The reflectivity of the mirror assembly is thus controlled. Dial marks are incorporated either on or in the light valve layer, or using a separation transparent layer.

### CROSS REFERENCE TO RELATED APPLICATIONS

This application claims the benefit of priority from U.S. Provisional Application Ser. No. 60/460,445 filed on Apr. 4, 2003.

### REFERENCE PATENTS

U.S. Pat. No. 4,747,086
U.S. Pat. No. 6,519,209
JP Laid Open Publication no. 07-280955

### BACKGROUND OF THE INVENTION

1. Field of the Invention

The present invention relates generally to a watch with a dial plate having a mirror function. More specifically, the invention relates to a watch with a dial plate having an electronically controllable mirror. In the normal operating state, the mirror is off. When the mirror is activated, it reflects light so that the user can conveniently use it for makeup or the like. A mirror dial plate with colors or other features incorporated in also presents an attractive watch face.

2. Description of the Related Art

Watches with various types of mirror functions are known in the prior art. A typical example of such a watch is disclosed in U.S. Pat. No. 4,747,086. The digital watch has a fluorescent display which is selectively actuated by depressing a button which extends through the watch casing. The watch crystal has a thin film mercury coating on the inner surface. The mercury coating may be sandwiched between the watch crystal and a thin transparent plastic film. When the fluorescent display is activated the display may be seen by the outside world through the watch crystal. However, when the fluorescent display is inactivated, the watch crystal appears as a mirror to the outside world.

Japanese Patent Publication No. 07-280955 discloses a watch having a half mirror crystal (lid). A LED light source is used to light up the dial face so that the time can be read through the crystal. The patent also discloses the use of a liquid crystal plate on the half mirror for making the dial plate and the hands visible.

More recently, U.S. Pat. No. 6,519,209 describes a display device for using in an electronic watch. The device utilizes an absorptive polarizer, a polarization change element (e.g., a liquid crystal cell), a reflective polarizer, and a reflector in sequence. In the device, a light ray transmitted through an area which varies a polarization axis, and gets reflected from the reflector to form a first returning light ray. Another light ray transmitted through an area which does not vary the polarization axis, and gets reflected from the reflective polarizer to form a second returning light ray. The first and second returning light rays present a background portion and a segment portion in a bright display. Both the first returning light ray and the second returning light ray are specularly reflected, presenting both the background portion and the segment portion in a mirror-like fashion. When both the background portion and the segment portion are reflected light ray from the same reflector, the display device is thus in a mirror mode. To display information, one of the background portion and the segment portion in a mirror-like image and the other in a matte image.

While the above mentioned devices are suited for their intended usage, all of the mirrors in the watches reflect only 50% or less of the light due the use of a permanent half mirror or polarizers. None of the above patents disclose a high reflectivity mirror. Further, none of the above patents discloses the use of a mirror with variable reflectivity controlled electronically. Inasmuch as the art is relatively crowded with respect to these various types of watches which have mirror functions incorporated in, it can be appreciated that there is a continuing need for and interest in improvements to such watches. In this respect, the present invention addresses this need and interest by providing a watch with a mirror dial plate assembly.

### BRIEF SUMMARY OF THE INVENTION

In view of the foregoing disadvantages inherent in the known types of watches having mirror functions now present in the prior art, the present invention provides a watch with a highly reflective mirror dial plate assembly.

It is therefore an object of the present invention to provide a new watch, quartz or mechanical, whose dial plate has a mirror incorporated in for appearance, makeup, or the like.

It is another object of the present invention to provide a new watch with a mirror function, which is controlled electronically for on and off, and variable reflectivity. The watch thus provides mirror and time display.

A further object of the present invention is to provide a new watch with a mirror function, which may be easily and efficiently manufactured.

Still another object of the present invention is to provide a new watch having an attractive mirror dial plate with color feature.

The objects are archived by replacing a regular dial plate of a watch with a mirror assembly comprising a light valve layer and a light reflective layer. The light valve is controlled by an electronic circuit for its on, off, and variable light transmission. The reflectivity of the mirror assembly is thus controlled. Dial marks are incorporated either on or in the light valve layer, or using a separation transparent layer. Optionally, the dial marks may be omitted. At normal operating state, the mirror dial plate looks like a regular dial plate. When the mirror is activated with a simple touch of a button, the dial plate is switched to a cosmetic mirror.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is a top plan view of a watch according to the present invention with the watch dial plate having a mirror assembly.

FIG. 2 is a cross sectional view taken along lines A-A of FIG. 1 and illustrating the interior (not showing the movement).

FIG. 3 is a cross sectional view of one embodiment showing the assembly of the mirror dial plate according to the present invention.

### DETAILED DESCRIPTION OF THE INVENTION

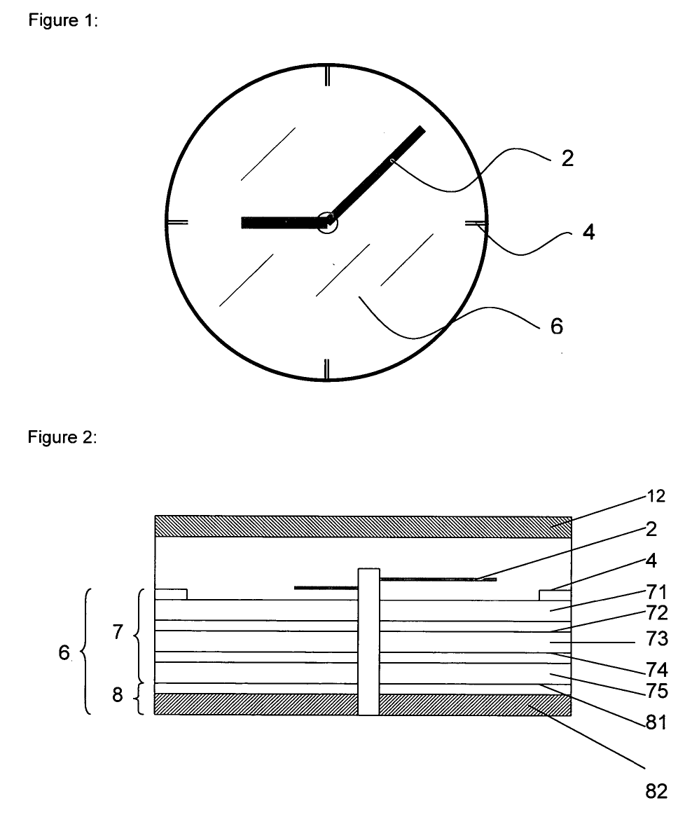

Referring to FIG. 1, an exemplary watch face having hands 2, dials 4, and a mirror dial plate assembly 6 is showed. The cross sectional view along the lines A-A is showed in FIG. 2. This view serves to illustrate the construction of one embodiment according to the present invention. The watch movement portion omitted in the cross sectional view. A mirror dial plate assembly 6 is placed under the watch crystal 12 and hands 2. The mirror assembly 6 comprises an electronically controllable light valve 7 and a mirror 8. The light valve comprises an electronically controllable media 73 (e.g., liquid crystals) sandwiched between two substrate plates 71 and 75. Both plates are transparent and are each coated with transparent conductive coating 72 and 74 as electrodes to operate the light valve. Under the light valve is the mirror 8 which comprises a mirror coating 81 and a substrate 82. Because a mirror coating is usually also an electrically conductive coating, it is thus preferred that the mirror 8 is integrated into the light-valve 7. That is, the conductive coating 74 and the substrate 75 are replaced by the mirror coating 81 and the substrate 82.

In a normal operating state, the light valve 7 is off. No light will pass through the valve. The dial plate 6 appears to be dark or opaque to the user. When the light valve is on by pressing a button on the watch case, light will pass through the valve, reach the mirror, and reflected. The dial plate 6 thus appears to be a mirror.

In order to have a practically useful mirror, the light valve technology should preferably provide a on-off transmission difference of at least 40% with a transmission less than 5% (or higher 95% of opaque) at the dark state, more preferably at least 60% transmission difference, and even more preferably at least 70% transmission difference.

There is no limit to which technology to use for the electronically controllable media. Technologies known to those in the art include, but not limited to, liquid crystal doped with dyes (host—guest), polymer dispersed liquid crystal, polymer stabilized cholesteric texture, electrochromes, suspended particles, electronic inks (such as the one disclosed in U.S. Pat. No. 6,014,247). Not only can these technologies provide an on-off mirror system, they are also capable to provide a mirror system with variable reflectivity.

Other features include decorative or color may be incorporated into the light valve. In case that a host—guest type liquid crystal technology is used as the light valve media, dichroic dyes having variety of colors can be chosen. In case that a suspended particle technology is used, the color can be varied by the color of the particles.

Addition features such as addressability in pixels may be incorporated in the light valve. Thus, variable information such as date can be displayed digitally.

Commonly used material for the transparent conductive layer 72 is indium tin oxide. Commonly used material for the conductive mirror coatings 74 is metallic, such as silver and aluminum.

There are numerous electronic circuits disclosed in literature and patents that could be used to control the light valve depending on the media of the valve. Circuits for controlling liquid crystal type or suspended particle type light valves can be found in, for example, U.S. Pat. Nos. 4,537,471, 5,617,111, 6,229,530, and 6,236,392. The disclosures of these patents are hereby incorporated by reference.

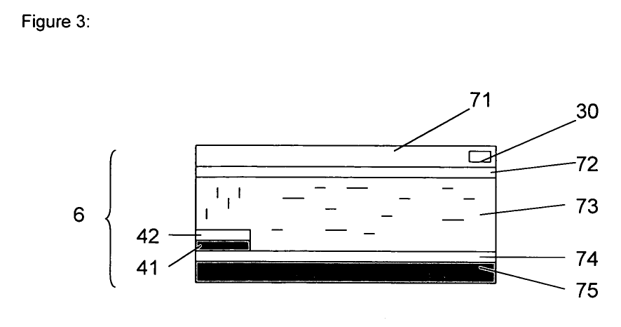

In another embodiment, referring to FIG. 3, the dial marks 4 are integrated in the mirror assembly. An electronically controllable mirror cell, which is a simplified version of a controllable dial plate, comprises a liquid control media 73 sandwiched between two plates 71 and 75. The top plate 71 is a transparent sheet material coated with transparent and conductive coating 72. The bottom plate 75 is a sheet material coated with an optically reflective (mirror) and electrically conductive layer 74. At areas where dial marks are needed, a stack of segmented two layers: conductive mirror coating 42 on insulating film 41, is placed on the back plate 75. Electric field is supplied between the transparent conductive layer 72 and conductive mirror layer 74, and between layer 72 and mirror layer 42. At the clear state, the light valve media 73 transmits light. Thus the cell acts as a mirror. At the dark state, the light valve media 73 blocks light. No light will be reflected off the mirror layer. Thus the cell will appear dark/opaque. The electric field between transparent conductive layer 72 and conductive mirror layer 42 is kept on so that marked dial can be seen.

There may be a light illuminating device 30 (e.g., a LED) inserted in the transparent substrate 71. The device 30 can be used to illuminate the dial plate in dark to assist the reading.

The figures discussed above and the various embodiments used to describe the principles of the present invention in this patent application are by way of illustration only and should not be construed in any way to limit the scope of the invention. Those skilled in the art will understand that the principles of the present invention may be implemented in any suitably arranged watches or other timepieces.

1. A watch having a mirror dial plate assembly comprising:
dial marks;
an electronically controllable light valve; and
a mirror plate,
wherein the light valve has a visible light transmission less than 5% at the dark state, and a visible light transmission higher than 55% at the clear state.

2. A watch as in claim 1 wherein said mirror plate is integrated into said light valve.

3. A watch as in claim 2 wherein said dial marks are integrated into said light valve.

4. A watch as in claim 1 wherein said light valve has a variable light transmission.

5. A watch as in claim 1 wherein said light valve has ability to display colors at the dark state.

6. A watch as in claim 1 wherein said light valve is addressable in pixels.
